(19) United States
(12) Patent Application Publication
(10) Pub. No.: US 2026/0171874 A1
(43) Pub. Date: Jun. 18, 2026

(54) ROTOR

(71) Applicant: Schaeffler Technologies AG & Co. KG, Herzogenaurach (DE)

(72) Inventors: Florian Nachtmann, La Wantzenau (FR); Alexander Keune, Karlsruhe (DE)

(73) Assignee: Schaeffler Technologies AG & Co. KG, Herzogenaurach (DE)

(21) Appl. No.: 19/126,809

(22) PCT Filed: Oct. 31, 2023
(86) PCT No.: PCT/DE2023/100798

§ 371 Date: May 2, 2025

(30) Foreign Application Priority Data
Nov. 3, 2022 (DE) 10 2022 129 063.8

(51) Int. Cl. H02K 9/19; H02K 1/22; H02K 7/00

(52) U.S. Cl. CPC H02K 9/19; H02K 1/22; H02K 7/003

(57) ABSTRACT

A rotor for a powertrain of a motor vehicle includes a rotor shaft and a rotor body rotationally fixed to the rotor shaft and made of a plurality of stacked rotor laminations. A plurality of first cooling channels extend through the rotor body in the axial direction. A first rotor shaft channel of the rotor shaft, through which a cooling fluid can flow and which is fluidically connected to a first supply channel that extends through the rotor body in the radial direction. The first supply channel opens into one of the first cooling channels at a first channel outlet. The first channel outlet includes a first fluid guiding element. When the rotor is being operated, a cooling fluid, to which a centrifugal force is applied, is supplied with a force component which acts in the axial direction when the cooling fluid exits the first channel outlet.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/DE2023/100798, filed on Oct. 31, 2023, designating the United States of America, which in turn claims the benefit of priority under 35 U.S.C. §§119, 365 of German Patent Application No. 102022129063.8, filed on Nov. 3, 2022, the contents of which are relied upon and incorporated herein by reference in their entirety.

### FIELD OF THE DISCLOSURE

The present disclosure relates to a rotor of an electric machine for, for example, a powertrain of a motor vehicle, comprising a rotor shaft and a rotor body which is rotationally fixed to the rotor shaft and is formed from a plurality of stacked rotor laminations and through which a plurality of first cooling channels run that extend in the axial direction through the rotor body, wherein the rotor shaft has a first rotor shaft channel which extends in the radial direction through which a cooling fluid can flow. The first rotor shaft channel is fluidically connected to a first supply channel that extends through the rotor body in the radial direction and opens into one of the first cooling channels extending in the axial direction.

### BACKGROUND OF THE DISCLOSURE

Electric motors are increasingly being used to drive motor vehicles to create alternatives to internal combustion engines that require fossil fuels. Significant efforts have already been made to improve the suitability of electric drives for everyday use and also to be able to offer users the driving comfort to which they are accustomed.

A detailed description of an electric drive can be found in an article in the German automotive magazine ATZ, volume 113, 05/2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. Such drive units are also referred to as e-axles or electrically operable powertrains.

In addition to purely electrically operated powertrains, hybrid powertrains are also known. Such powertrains of a hybrid vehicle usually comprise a combination of an internal combustion engine and an electric motor, and enable, for example in urban areas, a purely electric mode of operation while at the same time permitting both sufficient range and availability, in particular when driving cross-country. In addition, drive can also be provided by the internal combustion engine and the electric motor at the same time under certain operating situations.

In the development of electric machines intended for e-axles or hybrid modules, there is a continuing need to increase their power densities, so the cooling of electric machines required therefor is growing in importance. Owing to the necessary cooling capacities, hydraulic fluids such as cooling oils have become established in most concepts for the removal of heat from the regions of an electric machine which are subjected to heat.

For the stators of electric machines, for example, jacket cooling and winding head cooling are known from the state of the art for the realization of cooling of electric machines by means of hydraulic fluids. While jacket cooling transfers the heat generated at the outer surface of the laminated rotor core into a cooling circuit, in the case of the winding head cooling, the heat transfer into the fluid takes place immediately at the conductors outside the laminated rotor core in the region of the winding heads.

Further improvements are provided by separate cooling channels, which are introduced both in the stator laminated core (see, for example, EP3157138 A1) and in the groove, in addition to the conductors (see, for example, Markus Schiefer: Indirekte Wicklungskühlung von hochausgenutzten permanenterregten Synchronmaschinen mit Zahnspulenwicklung [Indirect Winding Cooling of Highly Utilized Permanently Excited Synchronous Machines with Toothed Coil Winding], dissertation, Karlsruhe Institute of Technology (KIT), 2017).

Concepts are also known in which hydraulic fluid flows directly around the windings to increase the power density. Improved cooling with direct contact of the hydraulic fluid and conductor in the groove is already known per se from the prior art. For example, DE102015013018 A1 describes a solution for electric machines with a single-tooth winding, wherein the fluid flows directly around the windings, which are wound around the teeth.

In addition to cooling the stators, it is also generally known to cool the rotors of electric machines.

### SUMMARY OF THE DISCLOSURE

An object of the disclosure is to realize a rotor which can provide a high cooling performance while at the same time having low leakage rates and manufacturing costs.

This object is achieved by a rotor of an electric machine for, for example, a powertrain of a motor vehicle, comprising a rotor shaft and a rotor body which is rotationally fixed to the rotor shaft and is formed from a plurality of stacked rotor laminations and through which run a plurality of first cooling channels that extend in the axial direction through the rotor body, wherein the rotor shaft has a first rotor shaft channel which extends in the radial direction and through which a cooling fluid can flow. The first rotor shaft channel is fluidically connected to a first supply channel of the rotor body which opens into one of the first cooling channels extending in the axial direction, wherein the first supply channel in the rotor body has a first channel outlet with a first fluid guide element which is designed such that the cooling fluid to which centrifugal force is applied during operation of the rotor is supplied with a force component which acts in the axial direction when the cooling fluid exits the first channel outlet.

This provides the advantage that a leakage current can be prevented by the direct radial loading of a gap between two rotor laminations in the rotor body. By subjecting the cooling fluid to an axial force component, the impact speed of the cooling fluid on the radially outer surfaces of the cooling channel is also reduced, which can also contribute to minimizing or completely avoiding a leakage flow.

According to some embodiments, a rotor is the rotating (spinning) part of an electric machine. The rotor comprises a rotor shaft. The rotor shaft can be hollow, which on the one hand results in weight savings and on the other hand allows the supply of lubricant or coolant to the rotor body. In various implementations, the hollow shaft of the contactless energy transmission device is a rotor shaft of a rotor of an electric machine that is hollow at least in sections.

The rotor comprises the rotor body. The rotor body can be made of a laminated rotor core and the permanent magnets inserted into the pockets of the laminated rotor core or fixed to the circumference of the laminated rotor core, as well as any axial cover parts for closing the pockets.

The rotor can have a plurality of rotor bodies. The rotor bodies can be formed substantially of the same parts and can be formed substantially identically. In an exemplary embodiment, the rotor bodies are formed from substantially identical rotor laminations. The rotor bodies can, for example, be formed from a laminated rotor core, which is composed of a plurality of laminated individual sheets or rotor laminations, made of, for example, electrical steel, which are layered and stacked one above the other to form a stack, what is termed the laminated rotor core. The individual laminations can be held together in the laminated rotor core by, for example, gluing, welding, or screwing. A laminated rotor core can also have permanent magnets that are inserted into the pockets of the laminated rotor core or that are fixed circumferentially to the laminated rotor core.

Rotor magnets are understood to be permanent magnets to be introduced into the pockets of the laminated rotor core. The permanent magnets can preferably be inserted into the pockets of the laminated rotor core. A single larger rotor magnet designed as a bar magnet or a plurality of smaller permanent magnetic elements can be provided for each pocket.

A laminated rotor core can form a rotor body. A laminated rotor core is understood to mean a plurality of laminated individual overlays or rotor laminations, which are stacked and packaged one on top of the other to form a stack or what is termed a “laminated rotor core”. The individual overlays can then remain held together in the laminated core by, for example, adhesive bonding, welding, or screwing. A laminated rotor core can also have magnetic elements inserted into the pockets of the laminated rotor core or the magnetic elements circumferentially fixed to the laminated rotor core as well as any axial cover parts for closing the pockets and the like.

The electric machine can be designed as a rotary machine. The rotary machine can be configured as a radial flow machine. A radial flow machine is thus distinguished by the fact that the magnetic field lines in the air gap formed between the rotor and stator extend in a radial direction. The gap between the rotor and the stator is referred to as the air gap. In a radial flow machine, this is an annular gap with a radial width that corresponds to the distance between the rotor body and the stator body.

The electric machine can be used within a powertrain of a hybrid or fully electrically driven motor vehicle. The electric machine can be dimensioned such that vehicle speeds of more than 50 km/h, more than 80 km/h, and/or more than 100 km/h can be achieved. The electric motor can have an output of more than 50 kW, more than 80 kW, and/or more than 150 kW. Furthermore, in some embodiments, the electric machine may provide speeds greater than 8000 rpm, greater than 12,000 rpm, and/or greater than 1500 rpm.

A motor vehicle can be a variety of types of vehicles, such as passenger cars, trucks, small motorcycles, light motor vehicles, motorcycles, motor buses/coaches or tractors.

According to an aspect of the disclosure, the cooling channels can be arranged on a circular path in the cross-section of the rotor body. The advantage of this design is that a particularly uniform cooling performance can be achieved. The diameter of the circular path can be sized such that the cooling channels run radially below the rotor magnets. The center of the circular path can run coaxially to the axis of rotation of the rotor.

According to an advantageous embodiment of the disclosure, the rotor body has a first cover plate positioned at a first axial end of the rotor body and the first cover plate defines the first supply channel. The first supply channel can be partially defined by the first cover plate (e.g., the first cover plate includes a groove that cooperates with another portion of the rotor body to define the first supply channel), in some implementations. The first supply channel can be completely defined by the first cover plate (e.g., channel defined by and extending through the first cover plate), in some implementations.

According to an embodiment of the disclosure, it can also be provided that the first supply channel comprises a first groove formed in the first cover plate, which defines the first supply channel with a rotor lamination of the rotor body resting on the front side of the first cover plate. This makes it possible to provide a variant of a supply channel that is particularly cost-effective in terms of manufacturing technology.

Furthermore, according to an embodiment of the disclosure, it can be provided that the first fluid guide element is formed as a first ramp inclined in the axial direction in the first groove. The advantageous effect of this design is based on the fact that this ramp can be manufactured particularly easily and cost-effectively.

According to an embodiment of the disclosure, it can be provided that the first fluid guide element is designed as a ramp inclined in the axial direction and protruding from the plane of the first cover plate, which has proven to be particularly advantageous with regard to avoiding a leakage flow

Furthermore, the rotor shaft may have a second rotor shaft channel which extends in the radial direction and have a first rotor shaft channel through which a cooling fluid can flow and which is fluidically connected to a first supply channel which extends in the radial direction through the rotor body and which opens into one of the second cooling channels which extend in the axial direction. The second supply channel in the rotor body has a second channel outlet with a second fluid guide element which is designed such that the cooling fluid which is subjected to centrifugal force during operation of the rotor is supplied with a force component which acts in the axial direction when the cooling fluid exits the second channel outlet. The rotor body may advantageously have a second cover plate which rests against a portion of the rotor body at a second axial end of the rotor body, and the second cover plate defines the second supply channel. The advantage of this design is that the rotor can be cooled from several sides.

It can also be provided that the first supply channel and the second supply channel are configured such that the cooling fluid flows through the cooling channels coupled thereto in different directions, which also contributes to improved cooling performance.

According to an aspect of the disclosure, it can be provided that the first cover plate has a first outlet opening extending axially through the first cover plate, which is fluidically connected to the first cooling channel and/or the second cover plate has a second outlet opening extending axially through the second cover plate, which is fluidically connected to the second cooling channel, so that a defined outlet point for the cooling fluid from the rotor body can be defined.

The first cover plate and/or the second cover plate can have a sensor reading region by means of which the rotor speed and/or the rotor position can be determined by a sensor. The advantage that this offers is that it enables a high degree of system integration.

### BRIEF DESCRIPTION OF THE DRAWINGS

The disclosure is explained in more detail below with reference to figures without limiting the general concept of the disclosure.

In the figures:

FIG. 1 shows a motor vehicle having an electric powertrain in a schematic block diagram;

FIG. 2 shows a schematic axial sectional view of an electric machine;

FIG. 3 shows a rotor in an axial sectional view;

FIG. 4 shows a detailed view of the channel outlet of the supply channel in an axial sectional view;

FIG. 5 shows a frontal view of a first cover plate of the rotor;

FIG. 6 shows a frontal view of a second cover plate of the rotor;

FIG. 7 shows a frontal view of the rotor body; and

FIG. 8 shows a first cover sheet in a first front view, a second front view, and a side view.

### DETAILED DESCRIPTION

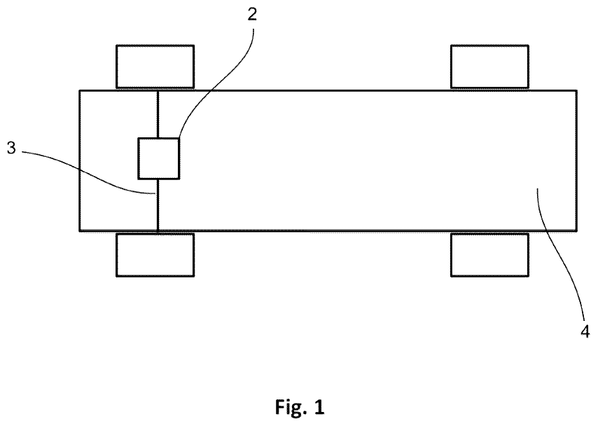

The disclosure is explained by way of example using an electric machine 2 for a powertrain 3 of a motor vehicle 4. Such a powertrain 3 is shown as an example in FIG. 1.

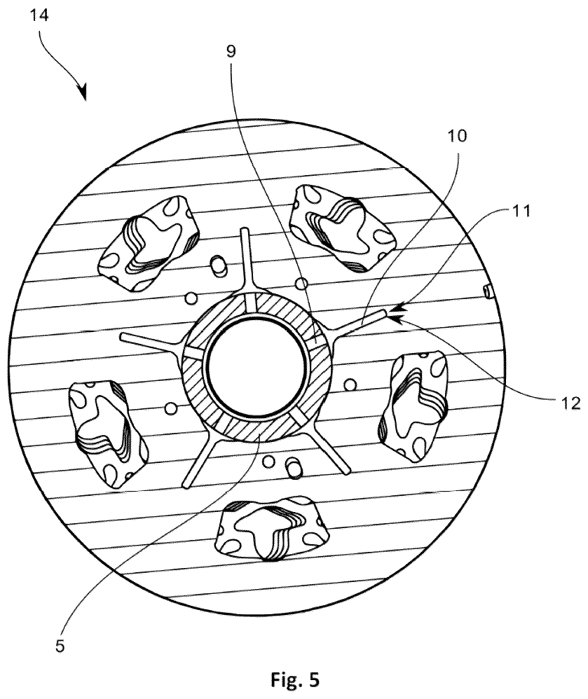

As can be seen from FIG. 5, the rotor 1 of the electric machine 2, which is rotatably mounted in the hollow cylindrical stator 29, comprises a rotor shaft 5 and a rotor body 6 which is rotationally fixed to the rotor shaft 5 and is formed from a plurality of stacked rotor laminations 13 and through which a plurality of first cooling channels 7 run that extend in the axial direction through the rotor body 6. The rotor shaft 5 has a first rotor shaft channel 9 which extends in the radial direction and through which a cooling fluid 8 can flow, which is fluidically connected to a first supply channel 10 which extends in the radial direction through the rotor body 6 and opens into one of the first cooling channels 7 which extend in the axial direction.

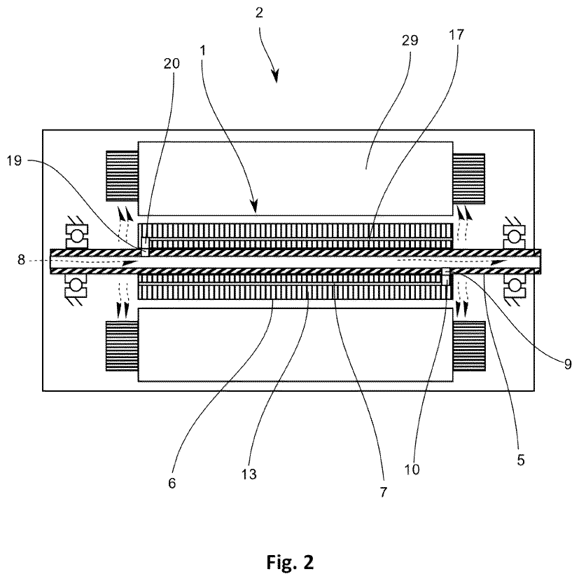

The first supply channel 10 in the rotor body 6 has a first channel outlet 11 with a first fluid guide element 12 which is designed such that the cooling fluid 8, which is subjected to centrifugal force during operation of the rotor 1, is subjected to a force component acting in the axial direction when it exits the first channel outlet 11. This can be clearly understood from the overview of FIGS. 2-4.

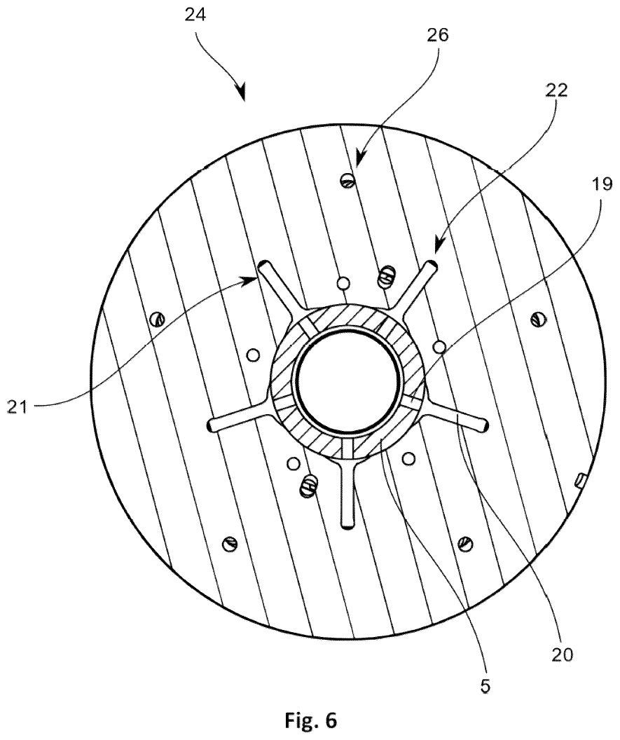

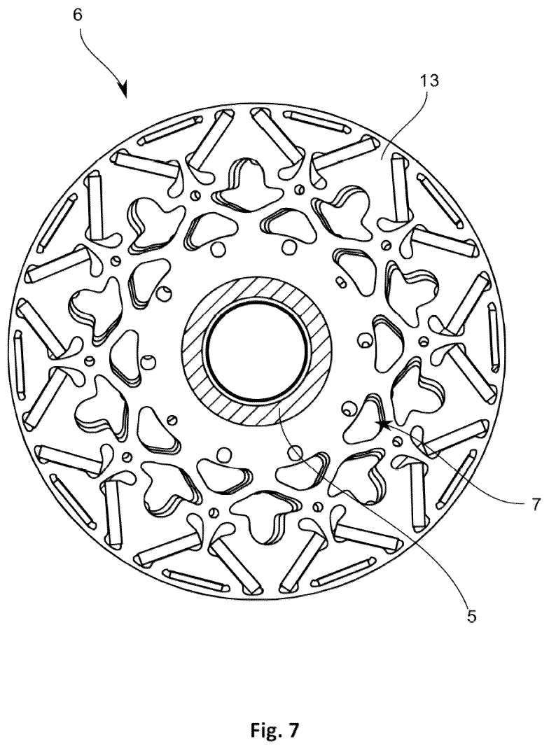

FIGS. 2-7 also show that the rotor shaft 5 has a second rotor shaft channel 19 which extends in the radial direction and through which a cooling fluid 8 can flow, which is fluidically connected to a second supply channel 20 which extends in the radial direction through the rotor body 6 and opens into one of the second cooling channels 17 which extend in the axial direction, wherein the second supply channel 20 in the rotor body 6 has a second channel outlet 21 with a second fluid guide element 22 which is designed such that the cooling fluid 8 which is subjected to centrifugal force during operation of the rotor 1 is subjected to a force component acting in the axial direction when it exits the second channel outlet 21.

In the embodiment shown, the first supply channel 10 and the second supply channel 20 are configured such that the cooling fluid 8 flows through the cooling channels 7, 17 coupled thereto in different directions.

For this purpose, the rotor body 6 has a correspondingly designed second cover plate 24 which rests against a second of the front ends of the rotor body 6 and the second cover plate 24 forms and/or has the second supply channel 20, which can be clearly seen from FIG. 2. The first cover plate 14 has a first outlet opening 25 which extends axially through the first cover plate 14 and is fluidically connected to the first cooling channel 7, so that the winding heads of the stator 29 can be supplied with cooling fluid 8 via this outlet opening 25 during operation of the electric machine 2.

Analogously, the second cover plate 24 also has a second outlet opening 26 which extends axially through the second cover plate 24 and is fluidically connected to the second cooling channel 17, so that the second winding head of the stator 29 of the electric machine 2 can also be supplied with the cooling fluid 8.

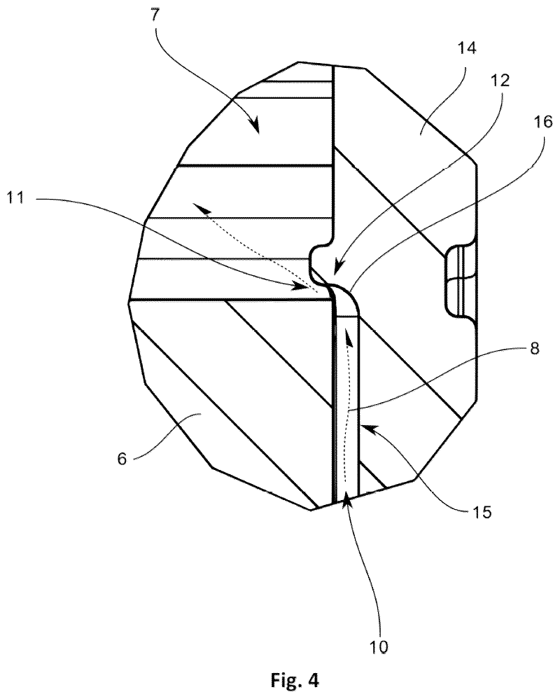

As can be clearly seen from FIG. 4, the first supply channel 10 is designed such that it protrudes only slightly beyond the radially inner end of the first cooling channel 7. The first cooling channel 7 has a first fluid guide element 12 which projects into the first cooling channel 7 and which, in the embodiment shown, is designed as a first ramp 16. The first fluid guide element 12 ensures that the cooling fluid 8 flowing radially outwards is directed into the first cooling channel 7. Cooling problems due to leakage losses in gaps radially above the supply channel 10 can be avoided in this way.

The first fluid guide element 12 thus functions as a flow separation edge. The cooling fluid 8 flies radially outward on the ramp 16 with an axial vector imposed by the ramp 16 until it hits the outer radius of the first cooling channel 7. Due to the free flight, the radial velocity is lower than if the cooling fluid 8 had been accelerated in a purely radial manner, i.e., without the axial deflection by the first fluid guide element 12, to the outer radius of the cooling channel 7. Due to the lower radial velocity in conjunction with the forced axial deflection, the cooling fluid 8 flows through the first cooling channel 7 of the rotor 1, instead of this radial-axial deflection taking place, for example, at the annular gap on the front contact surface between the rotor body 6 and the first cover plate 14.

The ramp 16 can, for example, be manufactured cost-effectively by inserting it into an aluminum stamped part. The passage may be located outside the flat surface of the sensor reading region 27.

In the embodiments shown, the cooling of the rotor 1 is achieved by introducing cooling fluid 8 from both sides into a plurality of star-shaped supply channels 10, 20 in the cover plates 14, 24. The rotor 1 is flowed through alternately from left to right. This allows a symmetrical oiling and cooling of the rotor 1 and the stator windings to be achieved.

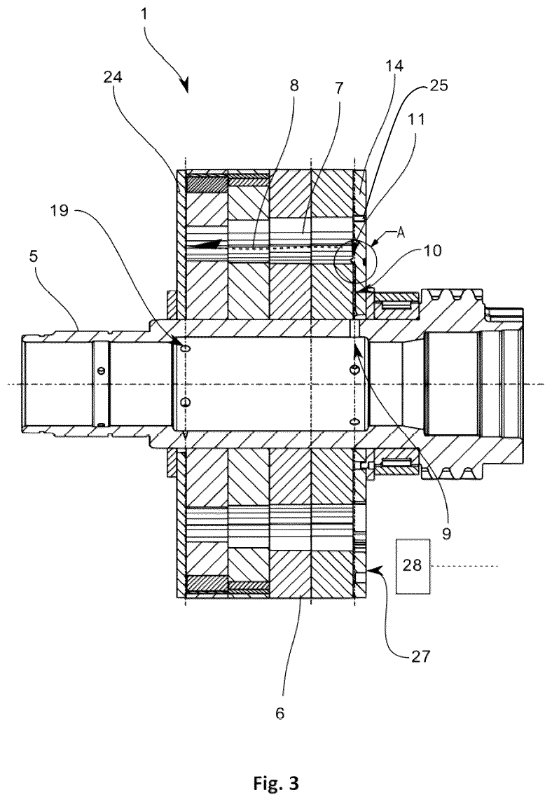

From FIG. 3 it is further apparent that the rotor body 6 has a first cover plate 14 which rests against a first axial end of a portion of the rotor body 6 and defines the first supply channel 10. The first supply channel 10 can be defined by a first groove 15 in the first cover plate 14, which defines the first supply channel 10 with a rotor lamination 13 (forming the first axial end) of the rotor body 6 abutting the first cover plate 14, as can also be clearly seen in FIG. 4. The first fluid guide element 12 is formed as a first ramp 16 inclined in the axial direction in the first groove 15, wherein this continues in a ramp 16 inclined in the axial direction and protruding from the plane of the first cover plate 14.

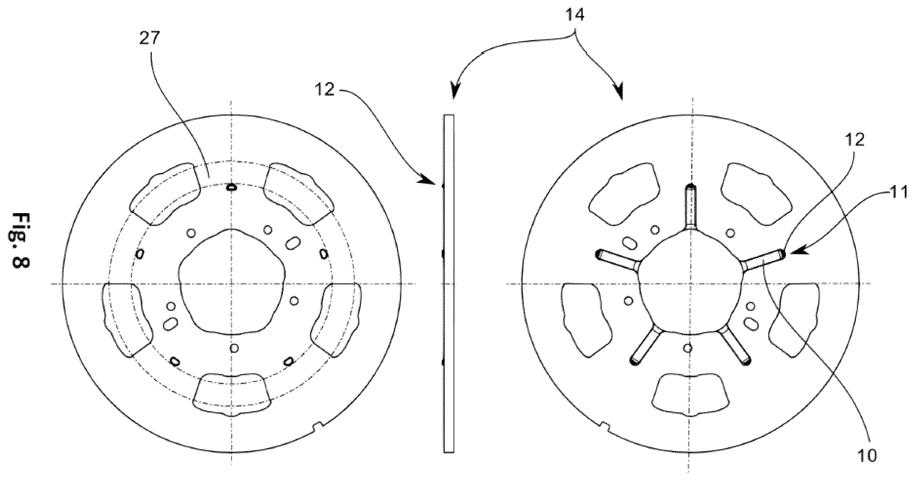

FIG. 8 shows that the first cover plate 14 has an annular sensor reading region 27, by means of which the rotor speed and/or the rotor position can be determined by a sensor 28.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define “first” and “second” features, this designation serves to distinguish between two features of the same type without defining an order of precedence.

### List of Reference Symbols

1 Rotor
2 Electric machine
3 Powertrain
4 Motor vehicle
5 Rotor shaft
6 Rotor body
7 Cooling channels
8 Cooling fluid
9 Rotor shaft channel
10 Supply channel
11 Channel outlet
12 Fluid conducting element
13 Rotor lamination
14 Cover plate
15 Groove
16 Ramp
17 Cooling channels
19 Rotor shaft channel
20 Supply channel
21 Channel outlet
22 Fluid conducting element
24 Cover plate
25 Outlet openings
26 Outlet openings
27 Sensor reading region
28 Sensor
29 Stator

1. A rotor of an electric machine, comprising:
a rotor shaft and a rotor body which is rotationally fixed to the rotor shaft and is formed from a plurality of stacked rotor laminations, through which a plurality of first cooling channels run that extend in the axial direction through the rotor body, the rotor shaft having a first rotor shaft channel extending in the radial direction through which a cooling fluid can flow, which is fluidically connected to a first supply channel extending in the radial direction through the rotor body, which opens into one of the first cooling channels extending in the axial direction, wherein the first supply channel in the rotor body has a first channel outlet with a first fluid guide element configured such that the cooling fluid, to which centrifugal force is applied during operation of the rotor, is supplied with a force component which acts in the axial direction when the cooling fluid exits the first channel outlet.

2. The rotor of claim 1, wherein the rotor body has a first cover plate disposed at a first axial end of the rotor body and that defines the first supply channel.

3. The rotor of claim 2, wherein the first cover plate includes a first groove that defines the first supply channel in cooperation with a rotor lamination of the rotor body axially adjacent to the first cover plate.

4. The rotor of claim 3, wherein the first fluid guide element is formed as a first ramp inclined in the axial direction in the first groove.

5. The rotor of claim 2, wherein the first fluid guide element includes a ramp inclined in the axial direction and protruding from a plane of the first cover plate.

6. The rotor of claim 2, wherein a plurality of second cooling channels extend axially through the rotor body, and the rotor shaft has a second rotor shaft channel extending in the radial direction through which a cooling fluid can flow, which is fluidically connected to a second supply channel extending in the radial direction through the rotor body and which opens into one of the second cooling channels extending in the axial direction, wherein the second supply channel in the rotor body has a second channel outlet with a second fluid guide element configured such that the cooling fluid that is subjected to centrifugal force during operation of the rotor is supplied with a force component which acts in the axial direction when the cooling fluid exits the second channel outlet.

7. The rotor of claim 6, wherein the first supply channel and the second supply channel are configured such that the cooling fluid flows through the first and second cooling channels respectively coupled thereto in different directions.

8. The rotor of claim 6, wherein the rotor body has a second cover plate disposed at a second axial end of the rotor body and that defines the second supply channel.

9. The rotor of claim 8, wherein the first cover plate has a first outlet opening extending axially through the first cover plate which is fluidically connected to the first cooling channel, and the second cover plate has a second outlet opening extending axially through the second cover plate and being fluidically connected to the second cooling channel.

10. The rotor of claim 8, wherein at least one of the first cover plate and the second cover plate includes a sensor reading region via which the at least one of the rotor speed and the rotor position can be determined by a sensor.

11. A rotor for an electric machine for a motor vehicle, comprising:
a rotor shaft including a first rotor shaft channel; and
a rotor body rotationally fixed to the rotor shaft and having a first cooling channel that extends axially within the rotor body and a first supply channel that is aligned with the first rotor shaft channel and extends radially outboard therefrom to a first channel outlet adjacent to the first cooling channel to fluidically connect the first rotor shaft channel and the first cooling channel, wherein the first channel outlet includes a first fluid guide element that is configured to deflect fluid flowing radially outboard within the first supply channel due to rotation of the rotor axially along the first cooling channel.

12. The rotor of claim 11, wherein the first fluid guide element includes a ramp that extends at an incline radially outboard and in a first axial direction relative to an adjacent portion of the rotor body that is radially inboard of the ramp to deflect the fluid along the first cooling channel in the first axial direction.

13. The rotor of claim 12, wherein the rotor body includes a plurality of stacked rotor laminations and a first end plate disposed at a first axial end of the plurality of stacked rotor laminations, and wherein the first supply channel is defined by the first cover plate.

14. The rotor of claim 13, wherein the first cover plate cooperates with one or more of the plurality of stacked rotor laminations to define the first supply channel.

15. The rotor of claim 14, wherein the first fluid guide element is a portion of the first cover plate.

16. The rotor of claim 15, wherein the first fluid guide element protrudes axially into the first cooling channel.

17. The rotor of claim 12, wherein the rotor shaft includes a second rotor shaft channel, and the rotor body includes a second cooling channel that extends axially within the rotor body and a second supply channel that is aligned with the second rotor shaft channel and extends radially outboard therefrom to a second channel outlet adjacent to the second cooling channel to fluidically connect the second rotor shaft channel and the second cooling channel, wherein the second channel outlet includes a second fluid guide element that is configured to deflect fluid flowing radially outboard within the second supply channel due to rotation of the rotor axially along the second cooling channel in a second axial direction that is opposite the first axial direction.
